(19) United States
(12) Patent Application Publication
(10) Pub. No.: US 2007/0003739 A1
(43) Pub. Date: Jan. 4, 2007

(54) SELF-ADHERING INSULATING PAD

(75) Inventor: Sarah S. Peterson, Seattle, WA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORP., Kent, WA (US)

(21) Appl. No.: 11/428,183

(22) Filed: Jun. 30, 2006

Related U.S. Application Data
(60) Provisional application No. 60/696,080, filed on Jun. 30, 2005.

(51) Int. Cl. B32B 1/00

(52) U.S. Cl. 428/174

(57) ABSTRACT

A self-retaining trivet includes a pad having a concave upper surface that is elastically deformable by a dish, or other vessel, such that it serves as a suction cup adhering itself to the dish. Grips may secure to the perimeter of the pad and facilitate removal of the trivet from the dish. The pad may have a convex lower surface having feet formed therein near the perimeter to stabilize the combined trivet and dish. In one embodiment, magnets secure to the pad or are embedded within the pad to facilitate securement of the trivet to pots made of a ferromagnetic material.

### PRIORITY CLAIM

This application claims the benefit of Provisional Application Ser. No. 60/696,080 filed Jun. 30, 2005, which is hereby incorporated by reference.

### FIELD OF THE INVENTION

This invention relates generally to insulating pads or trivets.

### BACKGROUND OF THE INVENTION

Many tables and counters have surfaces or surface treatments that can be damaged by heat. Accordingly, hot dishes must be placed on insulating pads or trivets to avoid damage. In typical situations it may be inconvenient to move a dish resting on an insulating trivet. Many dishes or pots also must be lifted with both hands. Accordingly, moving the underlying trivet is inconvenient. Typically, one must place a second trivet at the destination before moving the pot or dish. Furthermore, at a typical meal, passing hot dishes is made inconvenient by the need to constantly move the underlying trivet.

In view of the foregoing, it would be an advancement in the art to provide a trivet or insulating pad enabling convenient movement of both a dish and the underlying trivet at the same time.

### SUMMARY OF THE INVENTION

A self-retaining trivet includes a pad that can be adhere to a container. In one embodiment, the trivet has a concave upper surface that is elastically deformable by a dish, or other vessel, such that it serves as a suction cup adhering itself to the dish. Grips may secure to the perimeter of the pad and facilitate removal of the trivet from the dish. The pad may have a convex lower surface having feet formed therein near the perimeter to stabilize the combined trivet and dish and to facilitate removal. In one embodiment, magnets secure to a pad or are embedded within the pad (which may or may not be concave) to facilitate securement of the trivet to pots made of a ferromagnetic material.

### BRIEF DESCRIPTION OF THE DRAWINGS

Preferred and alternative embodiments of the present invention are described in detail below with reference to the following drawings.

FIG. 1 is lower quarter perspective view of a self-retaining trivet secured to a dish, in accordance with one embodiment of the present invention;

FIG. 2 is a side cross-sectional view of a self-retaining trivet, in accordance with one embodiment of the present invention;

FIG. 3 is a side view of a self-retaining trivet, in accordance with one embodiment of the present invention;

FIG. 4 is a lower quarter perspective view of a self-retaining trivet secured to a dish made of ferromagnetic material, in accordance with an embodiment of the present invention; and

FIG. 5 is a process flow diagram of a method for using a self-retaining trivet in accordance with an embodiment of the present invention.

### DETAILED DESCRIPTION OF THE PREFERRED EMBODIMENT

Referring to FIG. 1, a self-retaining trivet 10 may secure to the underside of a dish 12. A pad 14 forms the insulating portion of the trivet 10 and may cover a substantial portion of the underside of the dish 12. Grips 16 may secure to the perimeter, or other portion of the pad 14 and provide a structure for gripping by a user when removing the trivet 10 from the dish 12. Feet 18 may also be secured to the underside of the trivet pad 14. In some embodiments, the underside of the pad 14 is concave such that feet 18 serve to stabilize the trivet 10, which might otherwise be inclined to rock. The grips 16 and feet 18 may be formed integrally with the pad 14 or secure thereto by means of adhesive or the like.

In the preferred embodiment, the trivet is integrally formed of silicone. The use of silicone provides excellent heat resistant properties, and is also resilient for use as a flexible suction cup. Silicone may safely with stand temperatures of 500 degrees or more. Pots that are hot from the stove or oven and that would otherwise damage an underlying surface may therefore be supported by the pad 14. The integrally formed silicone trivet may also include an internal stiffening member formed of, for example, glass mesh or other webbing. In the embodiment as depicted in FIG. 1, the trivet pad 14, feet 18, and grips 16 are integrally formed of silicone. Other materials such as flexible plastics may also be used.

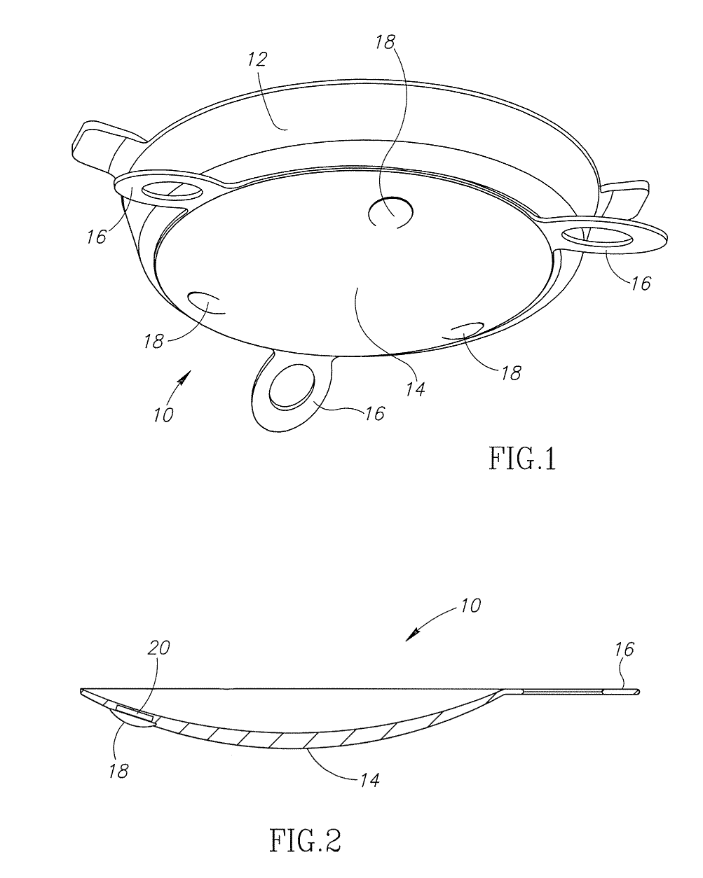

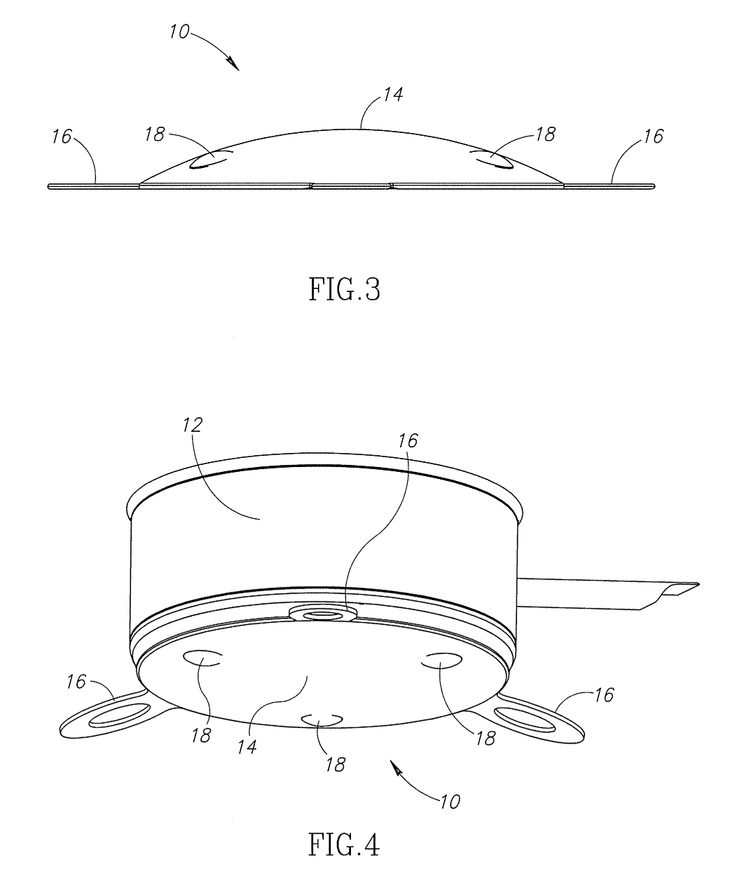

Referring to FIGS. 2 and 3, the pad 14 may be formed as a suction cup having a concave upper surface when at rest and separate from a dish 12. The lower surface may correspondingly be convex when at rest and separate from a dish 12. The concave upper surface and convex lower surface may have the same or different radii of curvature. In the illustrated embodiment, the concave upper surface has a larger radius of curvature such that the pad 14 is thicker at the center. In an alternative embodiment, the lower surface may be planar. In use, the pad 14 may be deformed into a more planar configuration such that the restoring force of the pad 14 creates a vacuum adhering the pad 14 to the dish 12.

The pad 14 may include additional material not forming part of a suction cup. For example, a pad 14 may be rectangular having a concave circular surface formed at the center thereof and having planar regions surrounding the concave circular surface. In other embodiments, the pad 14 may be a rectangular, or another noncircular shape, having a concave upper surface serving as a suction cup.

The feet 18 may serve to stabilize the pad 14 and dish 12 where the pad 14 is not deformed into a planar shape. Furthermore, inasmuch as the upper and lower surfaces have different radii of curvature in some embodiments, deformation of the pad 14 such that the upper surface is planar may nonetheless leave the lower surface somewhat rounded. In some embodiments, the lower surface may be planar, such that it may stably rest on a surface without the need of feet 18. In others, the pad 14 is of substantially constant thickness, such that deforming the upper surface into a planar configuration leaves the lower surface in a planar configuration as well. Alternatively, a ridge, or other structure may extend around the lower surface near the perimeter of the pad 14 and provide stabilization and additional insulating properties.

In some embodiments, magnets 20 secure to the pad 14 or are embedded in the pad 14. The illustrated embodiment includes three or more magnets 20 spaced evenly about near the perimeter of the pad 14. As shown in FIG. 2, the magnets are embedded within the material forming the pad 14, particularly within the material forming the feet 18. Placing the magnets within the feet allows for additional material to be used so that the magnets do not become dislodged or otherwise tear through the trivet. In alternate embodiments, the magnets are sized and configured such that they fit within the interior of the trivet, without feet or other surrounding bulged areas. In other embodiments, the magnets are attached to an upper or lower surface of the trivet. Further, while magnets are preferred, yet other means of attaching the trivet to a pan or dish are possible.

The magnets 20 facilitate securement of the trivet 10 to dishes 12 made of ferromagnetic material such as cast iron or steel, as shown in FIG. 4. As shown, the magnets and suction force combine to adhere the trivet to the bottom of a metallic pan. The concave shape, however, is not necessary for embodiments employing magnets. The trivet of FIG. 4, when configured with magnets of suitable size and strength, will cause the trivet to adhere to the bottom of a ferromagnetic pan even if the trivet is flat and has no suction force.

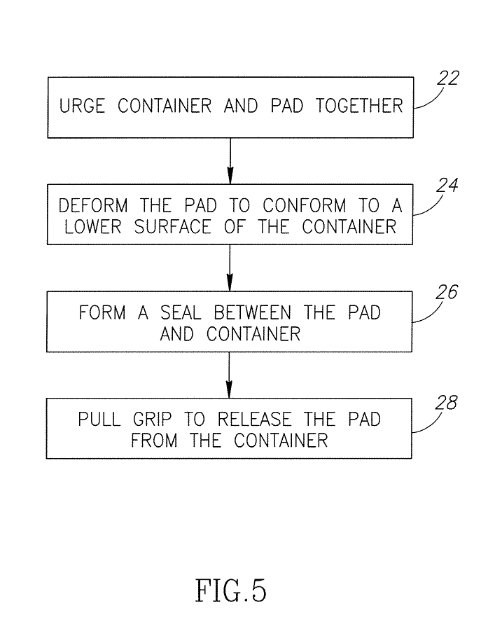

Referring to FIG. 5, a method for using the trivet 10 may include urging a container, such as the dish 12, toward the trivet 10 at block 22. Typically, this includes urging the lower surface of the container against the concave portion of the upper surface of the trivet 10. The method further includes deforming the trivet 10 at block 24. The trivet 10 is typically formed of an elastic polymer such that deforming 24 the trivet 10 causes an elastic restoring force. The trivet 10 may be deformed such that it substantially conforms to the lower surface of the container. Alternatively, the trivet 10 may be deformed sufficiently to create a restoring force of sufficient strength to retain the trivet 10 on the container. At block 26, a seal is formed between the lower surface of the container and the upper surface of the trivet 10 such that the restoring force results in a vacuum between the trivet 10 and the container. At block 28, the user pulls the grips 16 to release the trivet 10 from the container.

While the preferred embodiment of the invention has been illustrated and described, as noted above, many changes can be made without departing from the spirit and scope of the invention. Accordingly, the scope of the invention is not limited by the disclosure of the preferred embodiment.

1. An insulating pad comprising:
a central portion having an upper concave surface and a lower surface, the upper concave surface adapted to form a vacuum seal with a pot; and
wherein the pad is formed of a flexible, heat-resistant polymer.

2. The insulating pad of claim 1, wherein the lower surface is convex.

3. The insulating pad of claim 2, wherein the upper surface has a larger radius of curvature than the lower surface.

4. The insulating pad of claim 1, further comprising a plurality of feet on the lower surface.

5. The insulating pad of claim 4, further comprising at least one magnet attached to the pad.

6. The insulating pad of claim 5, wherein at least one magnet is embedded within the pad.

7. An insulating pad comprising:
a central portion having an upper surface and a lower surface; and
at least one magnet embedded within the pad;
wherein the pad is formed of a flexible, heat-resistant polymer.

8. A method for insulating a container comprising:
providing an insulating pad having a central portion having a concave upper surface;
urging a lower surface of a container having elevated temperature against the concave upper surface to reduce the concavity thereof, the upper and lower surfaces forming a seal to maintain a vacuum between the upper and lower surfaces.

9. The method of claim 8, wherein grips secure to a perimeter of the central portion, the method further comprising, pulling on the grips to release the silicone pad from the lower surface.

10. The method of claim 9, wherein the grips are formed monolithically with the central portion.

11. The method of claim 10, wherein the grips have a thickness less than a greatest thickness of the central portion.

12. The method of claim 8, wherein the container is a cooking pot having a planar lower surface.

13. The method of claim 8, wherein the container is a serving dish having a rounded lower surface.

14. The method of claim 8, wherein the lower surface is convex.

15. The method of claim 14, wherein the upper surface has a larger radius of curvature than the lower surface.

16. The method of claim 8, wherein a plurality of feet secure to the lower surface.

17. The method of claim 16, further comprising at least one magnet embedded in the central portion proximate the feet.

18. The method of claim 8, wherein the pad is formed of silicone.
